(19) United States
(12) Patent Application Publication
(10) Pub. No.: US 2011/0016421 A1
(43) Pub. Date: Jan. 20, 2011

(54) TASK ORIENTED USER INTERFACE PLATFORM

(75) Inventors: Eyal Krupka, Shimshit (IL); Igor Abramovski, Haifa (IL); Liza Fireman, Atlit (IL)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/505,837

(22) Filed: Jul. 20, 2009

(51) Int. Cl. G06F 3/048

(52) U.S. Cl. 715/780; 715/810

(57) ABSTRACT

An application management system may have a user interface in which a user may input a text phrase that describes a desired action. The system may generate metadata relating to the text phrase and distribute the metadata and text phrase to many different registered applications, some of which may be web based applications. Each application may return one or more suggested actions, along with some optional information from the application. The suggested actions may be ranked and presented on the user interface, and a user may select an action to be performed. The system may launch the application and have the action performed.

### BACKGROUND

In order to perform a seemingly simple task, a user may have to perform many mouse clicks in a given computer application. As computer applications become more powerful and flexible, a user may have to navigate many different user interface mechanisms, selections, and options to perform a desired task. In some cases, a user may have multiple ways to accomplish a desired task. This process may become more tedious and complex when the application is not readily available or open on a user interface.

Further complicating today's user is the fact that a user may interact with many different applications, each having different user interfaces, each of which may be complex and cause the user to be confused.

Even further complicating is the fact that many applications can operate on a mobile telephone or other device with very limited user interfaces. Such devices can be difficult to navigate to a particular application and enter large amounts of data and select from many different options.

### SUMMARY

An application management system may have a user interface in which a user may input a text phrase that describes a desired action. The system may generate metadata relating to the text phrase and distribute the metadata and text phrase to many different registered applications, some of which may be web based applications. Each application may return one or more suggested actions, along with some optional information from the application. The suggested actions may be ranked and presented on the user interface, and a user may select an action to be performed. The system may launch the application and have the action performed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a common user interface for many applications.

FIG. 2 is a flowchart illustration of an embodiment showing a method for processing a text phrase.

FIG. 3 is a diagram illustration of an embodiment showing an example of a user interface for a use scenario.

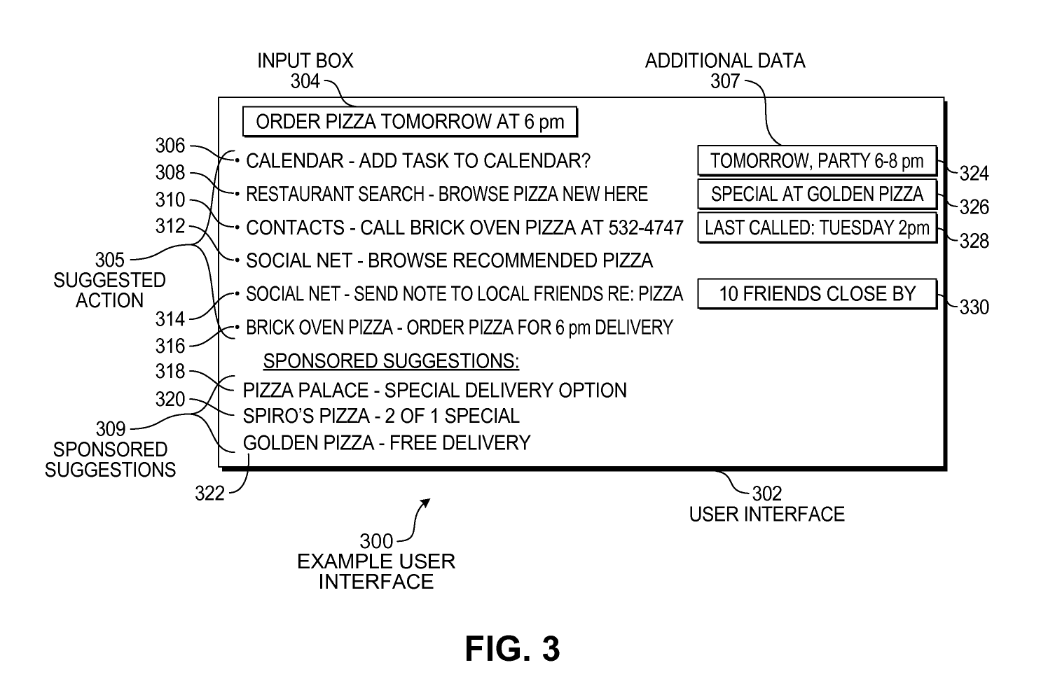

### DETAILED DESCRIPTION

An application management system may be capable of launching many different types of applications from a single, free text based user input. A text phrase may be input, then distributed to each of the registered applications. The registered applications may each parse and process the text phrase, then return suggested actions based on the text phrase. A user may launch the application and perform one of the suggested actions from the user interface.

The application management system may serve as a general purpose user interface from which many different types of actions may be performed on many different types of applications. After parsing the free text user input, various applications may generate scripts or use other procedures for executing a suggested action. The user may launch the script or perform the suggested action by merely selecting the suggested action.

The application management system may be used with many different types of applications, including locally available applications and remote applications such as web applications, social networks, and other applications and services. Each application may be registered with the application management system. In some cases, the registration system may involve configuring the application for a particular user or hardware configuration.

In many cases, metadata may be generated from the text phrase and distributed to the applications. The metadata may be generated by the application management system or may be provided by one or more applications that may parse the text phrase and return some metadata.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

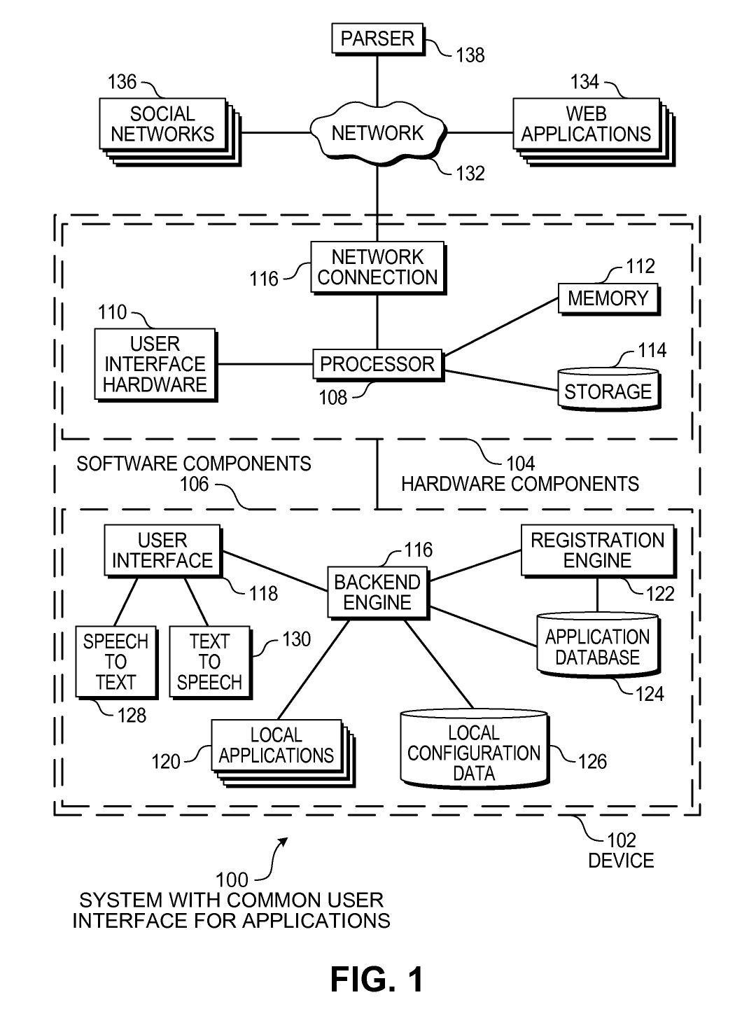

FIG. 1 is a diagram of an embodiment 100 showing an application management system. Embodiment 100 is a simplified example of an application management system that uses a single user interface to operate many different types of applications.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 illustrates a device 102 that contains hardware components 104 and software components 106. Embodiment 100 may be a device, such as a personal computer, that may perform many of the functions of an application management system. Other embodiments may have different architectures or different arrangements of hardware and software components, and some embodiments may have some components operable on a local device and other components operable on a remote device. Some such embodiments may be considered a client-server type architecture.

The device 102 may be any device that a user may use to interact with applications. In an embodiment such as a personal computer, the user may be acquainted with the various applications and may be able to interact with many applications separately. In some embodiments, the user may not be able to separately interact with the various applications or services. An example of such an embodiment may be a cellular telephone or other mobile device where the user may not have easy or direct access to an application or service.

Embodiment 100 may operate with a common user interface from which many different applications may be caused to perform certain tasks. A user may input a text phrase that may be parsed by multiple applications. Each application may determine an appropriate action in response to the text phrase, and the suggested actions from several different applications may be presented to the user. The user may select one of the suggested actions, and that action may be performed by the respective application.

The application management system may save a user many mouse clicks or other interactions in order to perform a simple action. For example, the action of adding a new reminder to a user's calendar application may involve navigating to the calendar application, opening the calendar application, navigating to the appropriate date for the reminder, selecting the appropriate time, and entering the reminder.

Using the application management system of embodiment 100, a user may enter a free text phrase “call Mom tomorrow at 6 pm”. The text phrase may be transmitted to a calendar application, which may respond with a suggested action that creates a reminder tomorrow at 6 pm with the text “call Mom”. The user may merely select the suggested action, and the application may implement the suggested action with or without further user interaction.

Continuing with the example above, the free text phrase “call Mom tomorrow at 6 pm” may also be transmitted to a telephone application. The telephone application may recognize the “call Mom” portions of the free text phrase and suggest an action of dialing a telephone call to a number listed under “Mom” in a telephone directory. In the example, the suggested actions by the two applications may be presented with an indicator for how well the suggested action matches the free text phrase.

In the case of the calendar application of the example, the calendar application was able to process the entire free text phrase. In the case of the telephone application, only the portion “call Mom” was recognized and processed. In such a situation, the suggested action by the calendar application may be ranked higher than that of the telephone application using the degree of the free text phrase that was processed or used by each application.

In the example, two different applications may have processed the text phrase and generated suggested responses. Each application may have certain data that it may use to assist the user. An example of such data may be the telephone application that may identify a telephone number listed for “Mom” in a telephone directory, and the telephone application may use the telephone number to place a call without having the user enter the telephone number.

The application management system may manage any application that may have an interface for the application management system. The interface may be capable of receiving a text phrase and returning a suggested action. The text phrase may include a preliminary parsing or have the free text phrase presented using a specific syntax or schema. In some embodiments, a text phrase may include metadata or other parameters.

The interface may receive a suggested action from an application that includes a descriptor of the suggested action and some definition to perform the action. The definition may include scripts, command line actions, application programming interface (API) calls, or other information by which the action may be performed. In such a case, the application may provide the mechanism by which an action may be performed.

In some embodiments, the interface may define several commands that may be supported by the various applications. In such embodiments, a definition of an action may include parameters that may be included in predefined commands supported by the interface.

As several applications provide suggested actions in response to the text phrase, the suggested actions may be presented to a user. The user may select an action to perform and the application may be launched with the various commands or parameters to perform the action. In some cases, the application may present additional user interfaces through which additional information may be collected or results displayed.

Some embodiments may generate metadata that is transmitted to the various applications along with the free text phrase. The metadata may include any type of additional information along with the text phrase, and various metadata may be used by different applications to provide relevant suggested actions. The metadata may include information gathered from local sources as well as other sources, such as remote sources. In some embodiments, a registered application may generate metadata that are shared to other registered applications. In such embodiments, the text phrase may be transmitted to certain applications which may return metadata from the parsed text phrase. Then, the metadata and the text phrase may be transmitted to the registered applications and the suggested actions may be returned.

The application management system may have several use scenarios. In one use scenario, a user may wish to place an order for pizza, for example. The user may enter “order pizza” into a text box of a user interface of the application management system. The application management system may gather metadata, such as the user's current location. Such metadata may come from a parameter associated with the user's device, or may come from an application that determines the metadata.

In the scenario, the text “order pizza” along with metadata which includes the user's location, may be sent to various applications to parse the text and generate suggested activities. In some cases, an application may receive the text phrase and may not be able to or may decline to provide a response. The applications may include a web search engine that uses the keyword “order” to search for a way to purchase a pizza. The search engine may use the user's location to generate a suggested activity of browsing local pizza restaurants. Another application may be a telephone directory application that may return a suggested action of placing a telephone call to a local pizza restaurant. A telephone contacts application may find a listing in a user's personal contacts for a pizza restaurant and present a suggested action of placing a telephone call to the restaurant.

In another scenario, a user may wish to find listing for a movie. The user may speak “find movie for this evening” into a microphone of the user's mobile telephone. A speech to text converter may generate a text phrase, and metadata may be generated by the mobile device, such as the user's location. The key phrase “this evening” may be passed to a calendar program to determine that the user has free time between 5 pm and 9 pm but has commitments after 9 pm. This schedule metadata may be transmitted along with the text phrase to applications such as a movie search engine, a map or navigation service, and a social network application.

In the scenario, the movie search engine may find movies physically near the user and within the timeframe of 5 pm to 9 pm, and may present suggested activities that may include purchasing a ticket or reading a review of movies available within the timeframe. The map or navigation service may present suggested activity that includes a map to the local theater. The social network application may present a suggested activity of sending a message to the user's friends about going to the movie. The social network application may determine a recommended movie from the user's friend's recommended movies.

Embodiment 100 provides a framework in which multiple applications may receive a text phrase and may suggest various actions. The actions may be presented to the user and may be launched based on the user's selection. When many suggested actions are presented, the suggested actions may be sorted, ranked, grouped, or otherwise organized so that more relevant suggested actions are presented.

In some embodiments, the ranking or sorting operations may be influenced by advertisements. In the example above of ordering a pizza, a local pizza restaurant may pay a certain amount of money for having its restaurant presented high on the list of suggested actions. Because the advertisement is being presented directly to a potential customer who wishes to order pizza immediately, the advertisement may be very effective and very valuable, and may provide a valuable revenue stream.

In embodiment 300 presented later in this specification, a user interface is presented along with a discussion of a complex use scenario that includes the use of advertisements.

The device 102 may have various hardware components 104 and software components 106. The example of embodiment 100 is merely one architecture on which an application management system may operate. The hardware components 104 may include a processor 108 and a user interface hardware 110. The processor 108 may be a general purpose processor that accesses memory 112, such as random access volatile memory, and may also have access to nonvolatile storage 114.

The hardware components 104 may represent various types of computing devices, such as laptop computers, desktop computers, personal computers, server computers, and other devices. In some cases, the hardware components 104 may be embodied in a mobile telephone, wireless network attached portable computer, a network appliance, personal digital assistant, or other device.

The user interface hardware 110 may be any mechanism by which information may be conveyed to a user and by which the user may convey information to the device 102. For example, a laptop computer may use a graphical display monitor to display information, and the user may enter text using a keyboard. The laptop computer may also have a mouse, joystick, touchpad, or other pointing and selecting devices. In another example, a mobile telephone may have a graphical display and may also use a speaker to present information using a text to speech converter. A mobile telephone may have a keypad or touchscreen for user input, as well as a speech to text converter to capture user input from a microphone.

Embodiment 100 shows various software components 106 as being contained in the device 102. In some embodiments, some of the software components 106 may be performed by other devices as services used by the device 102.

The software components 106 may include a backend engine 116 that may perform the processes of analyzing user input, generating metadata, sending and receiving communications with various applications, and presenting the suggested actions on a user interface 118. The backend engine 116 may cause an application to launch and perform a suggested action when one is selected from the user interface 118.

Embodiment 200, presented later in this specification, is an example of the operations that may be performed by a backend processor.

The backend engine 116 may create, process, and layout the information displayed or presented on a user interface 118. In many embodiments, a graphical user interface may be presented, and some embodiments may have speech to text 128 and text to speech 130 components for receiving and presenting audio information.

Embodiment 100 illustrates a locally operating set of software components 106 that operate on the device 102. In some embodiments, some components may be located remotely. For example, a parser 138 may be available over a network 132, which may be a local area network or a wide area network such as the Internet. The parser 138 may perform many or all of the operations of the software components 106 on the device 102. In such an embodiment, the device 102 may perform user interface functions but the processing of text phrases may be performed by the parser 138. In some such embodiments, the registration engine 122 and application database 124 may also be performed by the remote parser 138.

The application management system may interface with many different types of applications. In many cases, the applications may be local applications 120 that are executing or could be executed on the device 102, as well as web applications 134 and social networks 136 that may be available through a network 132.

The various applications may perform two functions: gathering metadata that may accompany a text phrase and analyzing the metadata and text phrase to generate suggested actions.

The applications may be managed with a registration engine 122 and information relating to the applications may be stored in an application database 124.

The registration engine 122 may receive applications to register and add those applications to the application database 124. In some embodiments, a user may select from a list of available applications to customize which applications are available. Some embodiments may perform automatic registration that may occur without direct user interaction. In one example of such an embodiment, a user may install a local application 120 on the device 102. As part of the installation process, the application may be registered with the registration engine 122 and made available for the backend engine 116 to use.

The registration engine 122 may perform various functions such as identifying applications and configuring the applications to perform various functions. Some applications may be identified for providing metadata but not suggested actions. Other applications may be identified for providing both metadata and suggested actions, while still other applications may be identified for providing only suggested actions.

In some cases, certain applications may be identified for parsing or processing certain types of data. For example, a calendar application may be used to parse or process time related information to generate schedule type metadata. In one use scenario, an initial parsing of a text phrase may identify some time related portion of a text phrase. The time related information or the entire text phrase may be sent to the calendar application which may return schedule metadata. Some such embodiments may be configured so that if no time related information was identified in the initial parsing, the calendar application may not be used to generate metadata.

In some embodiments, the registration engine 122 may generate a user interface through which a user may manually configure applications and identify how the applications may be used.

Some applications may be configured to be used in specific conditions, such as in response to a specific type of text phrase or for generating a specific metadata under certain conditions. Such configuration information may be stored in the application database 124.

The application database 124 may be used by the backend engine 116 to find applications to generate metadata and suggested actions. In some embodiments, a registered local application 120 may include an entry for a command line command, script, or application programming interface (API) call to the local application. Remote applications such as web applications 134 and social networks 136 may include entries with a Uniform Resource Locator (URL) address, API call, or other information that may be used to contact the remote application to generate metadata or suggested actions.

In some embodiments, the application database 124 may be located on a remote server, such as a server available through a network 132. One example may be a server accessed over the Internet.

Some embodiments may include a search mechanism in the registration engine 122. The search mechanism may identify applications that may be available and capable of processing metadata and suggested action requests using a text phrase. In some embodiments, the search mechanism may be used to search for available applications on demand or whenever a text phrase is processed.

In some embodiments, the search mechanism may search for available applications that may be added to the application database. Some embodiments may present a newly found application to a user to approve prior to adding to the application database. In some cases, the user may be able to perform some configuration of the application, such as define when the application can be used or to configure options for the application. An option may include providing the application with default values for some parameters or by customizing the application for the particular user. For example, a user may add an application for an auction application and may configure the auction application with a username and password.

A search mechanism may be configured to operate as a background process and crawl a local device, local area network, or some group of devices to determine if new applications are available. In some embodiments, the search mechanism may perform a daily or weekly search for new applications. Still other embodiments may submit a search query to a general purpose or specialty search engine over the Internet to identify new applications.

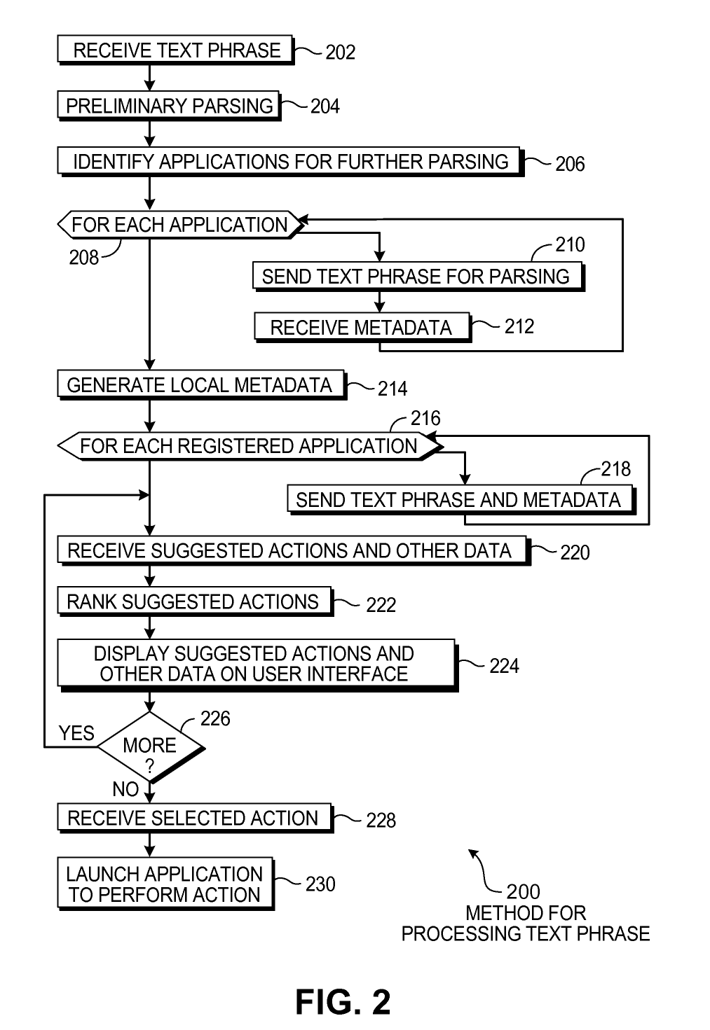

FIG. 2 is a flowchart illustration of an embodiment 200 showing a method for processing a text phrase. Embodiment 200 is a simplified example of a method that may be performed by a backend engine, such as backend engine 116 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 is an example of a process that may analyze a free text phrase, generate metadata using the text phrase, and send the metadata and text phrase to multiple applications for analysis. Each application may return with one or more suggested actions, which may be ranked and displayed for a user. When the user selects a suggested action, the application associated with the suggested action may be launched to perform the suggested action.

A text phrase may be received in block 202. The text phrase may be created by a user with some type of input device. For example, a mobile phone may use a microphone to receive audio input that may be converted to text. In another example, a personal computer user may type a text phrase using a keyboard.

The text phrase may be a free text phrase that describes what a user wishes to do. Different applications may parse and interpret the text phrase to determine what actions could be performed by the applications based on the text phrase.

In block 204, the text phrase may be preliminarily parsed. The parsing in block 204 may be used to categorize or analyze the text phrase to determine which applications can provide metadata relating to the text phrase. Those applications are identified in block 206. In some embodiments, the text phrase may be transmitted to applications without the preliminary parsing.

When a text phrase is received, the text phrase may contain words or phrases that may be used to generate metadata, and then the text phrase and metadata may be further analyzed by various applications which may generate suggested actions. In the metadata analysis, portions of the text phrase may be analyzed to gather information that may be used to suggest action from other applications.

In block 208, the applications identified in block 206 are each processed. The test phrase is sent to the application in block 210 and metadata is received from the application in block 212. After processing the applications in block 208, any local metadata may be generated in block 214.

The applications identified in block 206 may be identified by querying an application database, such as application database 124. In many embodiments, an application database may maintain a list of applications that may be capable of receiving metadata queries along with addresses, scripts, API calls, or other mechanisms by which the applications may be queried.

In some embodiments, the applications identified in block 206 may be identified by performing a search. In such embodiments, the search may be performed by searching a local directory system to identify applications that may be capable of responding to certain metadata queries. Some embodiments may involve sending a query to a remote search engine that may respond with web based or other remote applications that may be capable of providing metadata in response to specific text phrases.

The process of generating metadata may create a rich user experience that uses relevant information when soliciting suggested actions from various applications. Metadata may be generated by finding current information that relates to the text phrase. The metadata may relate to current events or status, user specific information, device specific information, or other information. The metadata may be gathered from the same applications for which suggested actions may be solicited, or may be gathered from other applications.

A text phrase may be parsed to identify a user's intention, parameters that may affect an action, or some other information. Metadata may be gathered based on the parsed information.

For example, a reference to a product in a text phrase may indicate that the user wishes to purchase a product or service. The user's intention may be deduced from keywords in the text phrase such as “get a new camera”, “order pizza”, “buy a car”, or “find a bookkeeper”. When a purchase can be implied, various applications may be queried for relevant metadata. For example, a money management application may be queried to determine the approximate amount of money the user has in a bank account or to determine what was the last purchase made by the user for the indicated item. One example may be the text phrase “order file folders”, which may generate metadata from previous purchases of file folders. The metadata may include the model number of the file folders. In this example, the user merely references “file folders”, but the metadata in block 212 may include the exact model number that the user prefers.

In another example, an implied purchase may trigger metadata queries to service providers with which the user has registered for an affinity program. For example, the user may be registered with an airline for frequent fliers. In many frequent flier programs, a member may generate frequent flier miles by purchasing products or services from various vendors when the user's frequent flier number is presented with a purchase. In such a case, an implied purchase may trigger a interaction with an airline's frequent flier program to determine the user's frequent flier number and a list of associated vendors. The list of vendors may be used as a list of preferred vendors for searching for an item, and the frequent flier number may be automatically transferred to a vendor if the user selects a suggested action with the vendor.

In block 204, an initial parsing of the text phrase may identify components of the text phrase for which metadata may be generated. In some embodiments, a secondary parsing may be performed by a specific application that is more suited to parsing specific types of data. For example, an initial parsing may reveal that the text phrase may contain a reference to time or date. The initial parsing may not be able to further classify the time or date reference, but the text phrase may be transmitted to a calendar application or other application that can perform more detailed or specialized parsing for time or date references and generate appropriate metadata based on the detailed parsing. The calendar application may have a more sophisticated parsing algorithm than the initial parsing.

Metadata may relate to the context of a device. The context of a device may be any information that relates to the configuration, operation, capabilities, or areas in which a device may operate. The context may include configuration parameters of the device, such as what options are enabled or disabled, for example. In some cases, the context may include which applications are available on a device or which applications are currently executing. The context may include which applications are operating, as well as data available within the application and even data currently displayed within an application. In some embodiments, the context may include the physical context, such as configuration of a network to which a device is connected or the availability of peripherals or devices.

In an example of context metadata, a user may enter a text phrase “help with line numbering”. The context of the query may include the software applications available to the device, such as three different word processing applications installed on the device. The context may further include an indication that one of the word processing applications is currently operating and may also include configuration data about the operating word processing application. When the text phrase and context metadata are transmitted to a search engine or help application, the suggested actions may be ranked to emphasize results that are specifically tailored to the currently operating word processing application and the context in which the word processing application is operating.

In the example above, the context data may include information that is currently displayed within the word processing application. When a user enters a text phrase that may be related to the word processing application, helpful metadata may include dialog boxes, menu items, or other displayed information from the word processing application, as well as format information, styles, or other information about the text displayed within the word processing application. These metadata may provide clues or help guide various applications in identifying helpful and useful suggested actions. For example, a suggested action may include step by step instructions or an automated script that produces line numbering in response to the text phrase above. The instructions or script may guide the user from the current state of the application to perform the requested task.

Metadata may relate to parameters that may affect an action. For example, an action that references a location may trigger metadata queries to a location service. A location service may determine a location for the user, the user's device, or some other location information.

In block 210, the entire text phrase or a portion of the text phrase may be sent to an application for parsing. In the case of the location service in the example above, a location service may return location information for the user as well as location information for persons or objects reference in a text phrase. For example, the text phrase “go to hockey rink” may return location information for the user based on a global positioning system (GPS) in the user's device as well as locations for “hockey rink” near the user.

In another example, a text phrase that references a time or date may trigger one or more calendar or schedule applications to parse the text phrase and return metadata. For example, the text phrase “call Mom tomorrow” may cause the user's schedule to be queried for tomorrow's date. The metadata may include unscheduled time that the user may be able to place a call. In some embodiments, a query to the user's mother's calendar may also be queried to determine metadata that may include free time when the user's mother is free to accept a call.

In some cases, some applications may be queried for metadata even if the parsing in block 204 does not indicate a specific intention. Some embodiments may always query a location service to determine a user location for every text phrase. For example, a text phrase “how to generate footnotes” may include the user's location information. The location information may be used to determine that the user is located in a specific country and may preferentially return help instructions that apply to word processing applications distributed in that country.

In another example, the text phrase “go to hockey rink” used above may include a query to a scheduling or calendar application even though the text phrase does not specifically reference a calendar or time parameter. The calendar application may search for “hockey rink” and return metadata that identifies the precise hockey rink the user has previously visited or may identify the hockey rink that may be identified in an appointment in the near future.

The local metadata in block 214 may be any metadata that can be gathered from a local device. The metadata generated in block 214 may be generated by reading a configuration file, accessing a configuration database, or other mechanisms. In many cases, metadata may be generated by transmitting the text phrase or portions of the text phrase to various local and remote applications and services then receiving metadata, such as in blocks 206 through 212. In other cases, metadata may be generated by reading configuration data directly from a local source in block 214 and may not involve transmitting the text phrase to an application or service.

In block 216, each registered application is processed and each registered application may be sent the text phrase and metadata in block 218. In block 220, suggested actions and other data may be received from the registered applications.

The registered applications may be any application that is registered to process text phrases and return suggested actions. A registered application may be managed by a registration engine, such as the registration engine 122. Registered applications may have some information stored in an application database, such as the application database 124.

In some embodiments, a search may be performed to identify applications to process a text phrase and return suggested actions. In one such embodiment, a search query may be transmitted over a network such as the Internet to a search engine to identify registered applications. Some such embodiments may perform the search periodically and store the results in a local application database. Other embodiments may perform such a search when processing each text phrase.

Embodiment 200 illustrates a process flow where each registered application may be sent a text phrase and metadata in block 218, then registered applications may respond with suggested actions and other data as the registered applications identify results. The process flow of embodiment 200 allows applications to respond or not. In such embodiments, an application that cannot process the text phrase or cannot suggest an appropriate action may decline to respond. In other embodiments, a process may expect to receive a response from each and every application to which a text phrase and metadata is sent.

An application may send one or more suggested actions in response to a text phrase and metadata. In some cases, an application may be able to interpret the text phrase into several different suggested responses.

After receiving the suggested actions in block 220, the suggested actions may be ranked in block 222 and displayed on a user interface in block 224. The condition in block 226 may allow for more suggested actions to be received by returning to block 220.

As the suggested actions are received and presented in the user interface, a user may browse the list of suggested actions and may select one. When the selection is made, the selected action may be received in block 228 and the application may be launched to perform the selected action in block 230.

An example of a user interface is presented in embodiment 300 presented later in this specification.

The suggested actions received in block 220 may include instructions or other mechanism by which the suggested action may be performed. The instructions may include commands, scripts, or other calls that may be used to cause the application to start operation and begin performing the suggested action. In some cases, the application may present additional user interfaces and may collect additional data from a user in order to perform the suggested action. In such cases, the suggested action may include commands that begin the suggested action. Other embodiments may include instructions that allow the suggested action to be performed to completion with or without user interaction.

Embodiment 300 is a sample user interface of an example of a use scenario for a system for processing text phrases with multiple applications. Embodiment 300 is a simplified example that illustrates one use scenario that incorporates web applications and social networks in response to a text phrase input.

Embodiment 300 along with the other examples described herein are merely some simple examples that may show the concepts and operations of the various embodiments. The examples are meant to illustrate how a text phrase processing system may be used but the examples are not meant to be limiting in any manner.

A user interface 302 may include an input box 304 and multiple responses to an input text phrase from various applications and illustrates a use scenario.

In the use scenario, a user enters a text phrase “order pizza tomorrow at 6 pm”. When the text phrase is received, it may be parsed and various metadata may be generated for the text phrase. The results of a process similar to that of embodiment 200 may include suggested actions 305, additional data 307, and sponsored suggestions 309.

The suggested actions 305 include responses from various applications that a user may have available, as well as social networks and applications provided by vendors.

Suggested action 306 may be a suggested action for a calendar application where the suggested action is to add a task to the user's calendar. This suggested action may recognize the time characteristics of the text phrase, specifically “tomorrow at 6 pm”, and suggest an action of creating a task in the calendar. If the user were to click on the suggested action 306, the calendar application may be launched with a user interface to create a task. When the calendar application launches, the values for task start time may be filled in for 6 pm on the next day. In such a case, the user may be able to edit the task that may be created before causing the task to be stored in the calendar.

The additional data 307 may include supplemental data relevant to a particular action and may assist the user in determining if a selected action is appropriate. For example, suggested action 306 includes additional data 324 that shows a calendar item related to the text phrase in the input box 304. In the example, the calendar application may recognize the time characteristics “tomorrow at 6 pm” and may show a calendar item of a party that is scheduled for tomorrow from 6-8 pm.

Suggested action 308 may be a suggested action from a restaurant search application. The restaurant search application may be triggered by the words “order pizza” in the text phrase. The restaurant search application may present a suggested action of “browse pizza near here”. If the user were to select the suggested action 308, a restaurant search engine may present various listings of pizza restaurants and other restaurants near the user's location.

In the example of suggested action 308, the user's location may be metadata that is determined when a query is launched. If the user were to select the suggested action 308, the user's location may be transmitted to the restaurant search engine to narrow the search results to restaurants near the user.

The suggested action 308 may have additional data 326 that illustrates an advertisement for “Special at Golden Pizza”. The advertisement may be a paid advertisement that is provided by the restaurant search engine, for example.

Suggested action 310 may be a suggested action from a contact management application. In the contact management application, a user may have entries for various people and businesses. In the example of suggested action 310, the user may have an entry for Brick Oven Pizza. When the contact management application receives the text phrase “order pizza tomorrow at 6 pm”, the contact management may recognize “pizza” and “order”, then present a suggested action to call the contact in the user's contact list that may be related to “pizza”.

Additional data 328 may present a relevant piece of information relating to the contact of Brick Oven Pizza. In this example, the additional data 328 states “Last Called: Tuesday 2 pm”. In this example, the contact management application may search for any relevant information regarding the contact of Brick Oven Pizza. In some cases, the additional data 307 may include maps to the contact location, addresses of the contact, or other information.

The suggested actions 312 and 314 may be examples of social networking applications. Many different social networks exist, and many have a mechanism by which users may establish relationships with each other. In some social networks, two people may be related by establishing a friend relationship. As more and more people establish relationships with each other, a web or network of connections may be established.

Within each social network, users may add information to the network. For example, some users may rank restaurants, provide reviews for restaurants, or indicate that they like or dislike restaurants. The suggested action 312 may be to browse recommended pizza restaurants within a user's social network.

In many cases, a social network may be used to communicate between users of the social network. The suggested action 314 may be to send a note to local friends about pizza. If a user were to select the suggested action 314, the social network application may send an instant message, email message, or other communication to members of the user's social network alerting the members that the user is planning to have pizza. This action may invite the user's friends to the user's location to share the pizza.

The additional data 330 may include information about the user's friends from the social network. In this case, the additional data states “10 friends close by”. The additional data may be generated by the social network and may be another example of using location metadata within a query.

In some embodiments, the additional data 307 may be an interactive component that may launch the responding application to show the additional data in more detail. For example, the additional data 330 may be a hotspot or other user interface mechanism by which the user may launch the social network application and display which of the user's 10 friends are close by.

Suggested action 316 may illustrate an example of a specialized application or website that may process a text phrase. In the example of suggested action 316, a website or application operated by Brick Oven Pizza may receive and process the text phrase. The suggested action provided by the Brick Oven Pizza website may be “order pizza for 6 pm delivery”. If the user were to select the suggested action 316, a user interface may be presented so that the user may select a specific type of pizza or customize an order. Once the pizza is selected, an electronic message may be transmitted to Brick Oven Pizza to place the order for the pizza.

In some embodiments, sponsored suggestions 309 may be advertisements or other suggested actions that may be presented to a user. The sponsored suggestions 309 may be the result of a payment made by an advertiser to have their suggested actions presented to a user. In many cases, advertisers may pay different fees and the ranking or positioning of their suggested actions may be based on the amount of money paid for the advertisement.

Suggested action 318 may be for Pizza Palace and may indicate that Pizza Palace has a special delivery option. If a user were to select suggested action 318, an application may be launched to put the user in contact with Pizza Palace directly. For example, a telephone application may be launched that automatically dials Pizza Palace. In another example, a user interface may launch where a user may select a pizza to have delivered. After selecting the desired pizza, an electronic communication may be transmitted to Pizza Palace. Suggested actions 320 and 322 may operate similarly.

The example of embodiment 300 is merely one example of several use scenarios for the embodiments 100 and 200 presented earlier in this specification. The examples throughout this specification are meant to illustrate how the embodiments may function and how they may be used and are not indented to be limiting in any manner.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method being performed on a computer processor, said method comprising:
receiving a text phrase;
generating metadata related to said text phrase;
transmitting said metadata and said text phrase to a plurality of applications;
receiving suggested actions from at least one of said plurality of applications;
presenting said suggested actions in a user interface;
receiving a selection of a first suggested action from said user interface, said first suggested action being associated with a first application; and
causing said first application to perform said first suggested action.

2. The method of claim 1, said metadata relating to a context of operation.

3. The method of claim 2, said context being defined by at least one currently executing application.

4. The method of claim 3, said context being further defined by currently displayed data within said currently executing application.

5. The method of claim 3, said context being further defined by currently available data within said currently executing application.

6. The method of claim 1, said metadata comprising location information.

7. The method of claim 1 further comprising:
performing a first parsing of said text phrase to identify a second type of parsing to be performed on said text phrase;
identifying a second application to perform said second type of parsing;
transmitting said text phrase to said second application; and
receiving at least a portion of said metadata from said second application after said second application performs said second parsing.

8. The method of claim 1, at least one of said plurality of applications being a web application.

9. The method of claim 8, said web application comprising a social network.

10. The method of claim 1, at least one of said plurality of applications being a locally executing application.

11. The method of claim 1, said text phrase being received from a speech to text component.

12. A system comprising:
a user interface;
a backend engine operable on a computer processor, said backend engine configured to:
receive a text phrase from said user interface;
generate metadata related to said text phrase;
transmit said metadata and said text phrase to a plurality of applications;
receive at least one suggested action from one of said plurality of applications;
causing said suggested action to be presented on said user interface;
receive a selected suggested action from said user interface, said selected suggested action being capable of being performed by a first application; and
causing said selected suggested action to be performed by said first application.

13. The system of claim 12 further comprising:
a registration system configured to:
receive registration information about a new application; and
store said registration information such that said backend engine may transmit said metadata and said text phrase to said new application.

14. The system of claim 13 further comprising:
an application database configured to store said registration information.

15. The system of claim 12, said user interface comprising a graphical user interface.

16. The system of claim 12, said user interface comprising an audio user interface.

17. The system of claim 12, said backend engine further configured to:
rank a plurality of said suggested actions; and
present said plurality of said suggested actions based on said ranking.

18. A method being performed on a computer processor, said method comprising:
receiving a text phrase from a user interface operating on a first device;
generating metadata related to said text phrase, said metadata comprising context information about said first device and metadata derived from at least one application;
transmitting said metadata and said text phrase to a plurality of applications;
receiving a plurality of suggested actions from at least two of said plurality of applications;
receiving at least one set of application data from one of said plurality of applications;
presenting said plurality of suggested actions and said set of application data in a user interface;
receiving a selection of a first suggested action from said user interface, said first suggested action being associated with a first application; and
causing said first application to perform said first suggested action.

19. The method of claim 18, said plurality of applications comprising at least one web application.

20. The method of claim 19, said web application comprising a social network.
